(19) United States
(12) Patent Application Publication
(10) Pub. No.: US 2026/0109265 A1
(43) Pub. Date: Apr. 23, 2026

(54) Device for Cooling Battery System of Vehicle Provided with Multi-Inlet Duct

(71) Applicants: Hyundai Motor Company, Seoul (KR); Kia Corporation, Seoul (KR)

(72) Inventors: Hong Goo Han, Hwaseong-Si (KR); Youngho Moon, Hwaseong-Si (KR)

(21) Appl. No.: 19/073,858

(22) Filed: Mar. 7, 2025

(30) Foreign Application Priority Data
Oct. 18, 2024 (KR) 10-2024-0142813

(51) Int. Cl. B60L 58/26; H01M 10/613; H01M 10/625; H01M 10/635; H01M 10/6563

(52) U.S. Cl. CPC B60L 58/26; H01M 10/613; H01M 10/625; H01M 10/635; H01M 10/6563

(57) ABSTRACT

Disclosed is a device for cooling a battery system of a vehicle provided with a multi-inlet duct. The cooling device includes an inlet duct including an inside air introduction port as an entrance to receive air from an interior space of a vehicle body and an outside air introduction port as an entrance to receive air from the outside of the vehicle body, a filter unit mounted to the outside air introduction port to filter out moisture and particles having a predetermined size or greater, a blower fan provided in the inlet duct to cause air to flow in a predetermined direction, a cooling duct configured to allow air introduced into the inlet duct to exchange heat with the battery system while flowing along a predetermined path, and an outlet duct as a passage to discharge air having passed through the cooling duct.

### CROSS-REFERENCE TO RELATED APPLICATION(S)

This application is based on and claims the benefit of 35 U.S.C. 119 to Korean Patent Application No. 10-2024-0142813, filed on Oct. 18, 2024, in the Korean Intellectual Property Office, the disclosure of which is herein incorporated by reference in its entirety.

### TECHNICAL FIELD

The present disclosure relates to a device for cooling a battery system of a vehicle provided with a multi-inlet duct. More particularly, the present disclosure relates to a device for cooling a battery system of a vehicle capable of selectively using air inside the vehicle and air outside the vehicle to cool the battery system and automatically cleaning an outside air introduction port.

### BACKGROUND

There is increasing demand for environmentally-friendly transportation means such as hybrid electric vehicles and electric vehicles. These vehicles are powered by electric energy stored in a battery system.

Electric energy may be stored in a battery system formed by multiple battery cells. These battery cells may be densely disposed in a limited space, and thus heat released from the battery cells may cause overheating of the battery system.

Overheating may deteriorate performance and reduce a lifespan of the battery system. In order to prevent this, a cooling device may be mounted in the battery system of a hybrid electric vehicle or an electric vehicle.

The battery system should accommodate as many battery cells as possible within a given volume and weight, and the internal temperature thereof should be efficiently controlled.

A conventional air-cooling type battery cooling device circulates air inside the vehicle to cool the battery in order to block introduction of foreign substances from the outside.

However, if an air-conditioning device of the vehicle is driven in order to cool the battery, an interior temperature of the vehicle may become uncomfortable (e.g., to occupants) or problematic for cargo that may get too hot. Further, driving a separate air-conditioning device for cooling of the battery may reduce energy efficiency (require additional energy expenditure).

Therefore, there is a need for technology capable of solving the above problems.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a device for cooling battery system of vehicle provided with multi-inlet duct. A device for air-cooling a battery system may comprise: an inlet duct comprising an inside air introduction port configured to receive air from an interior space of a vehicle body, and an outside air introduction port configured to receive air from outside of the vehicle body; a filter configured to filter, from air received from the outside air introduction port, moisture or particles having at least a predetermined size; a blower fan configured to cause air, from the inlet duct, to flow in a first direction; a cooling duct configured to allow air, introduced via the inlet duct, to exchange heat with the battery system while flowing along a predetermined path; and an outlet duct configured to discharge air from the cooling duct.

A method for air cooling a battery system of a vehicle, the method comprising: receiving, by a computing device and from one or more temperature sensors, an outside air temperature of air outside of the vehicle and an inside air temperature of air inside the vehicle; and controlling, by the computing device and based on a comparison of the received outside air temperature and the received inside air temperature, a valve of an inlet duct to a cooling duct configured to exchange heat with the battery system.

A vehicle comprising: a battery system; and a device for air-cooling the battery system. The device may comprise: an inlet duct comprising an inside air introduction port configured to receive air from an interior space of a vehicle body, and an outside air introduction port configured to receive air from outside of the vehicle body; a filter configured to filter, from air received from the outside air introduction port, moisture or particles having at least a predetermined size; a blower fan configured to cause air, from the inlet duct, to flow in a first direction; a cooling duct configured to allow air, introduced via the inlet duct, to exchange heat with the battery system while flowing along a predetermined path; and an outlet duct configured to discharge air from the cooling duct. The device may be configured to perform the method disclosed herein.

These and other features and advantages are described in greater detail below.

### BRIEF DESCRIPTION OF THE DRAWINGS

The above and other objects, features, and other advantages of the present disclosure will be more clearly understood from the following detailed description taken in conjunction with the accompanying drawings, in which:

FIG. 1 is a schematic view for explaining a device for cooling a battery system of a vehicle according to an example of the present disclosure;

FIG. 2 is a view schematically showing the device for cooling a battery system of a vehicle according to the example of the present disclosure;

FIG. 3 is a block diagram for explaining the device for cooling a battery system of a vehicle according to the example of the present disclosure;

FIG. 4 is a block diagram for explaining an inlet duct in the device for cooling a battery system of a vehicle according to the example of the present disclosure; and

FIG. 5 is a flowchart for explaining a method of operating the device for cooling a battery system of a vehicle according to an example of the present disclosure.

### DETAILED DESCRIPTION

Hereinafter, examples of the present disclosure will be described in detail with reference to the accompanying drawings.

The suffixes “module” and “unit” for constituent elements used in the following description do not have mutually distinguished meanings or roles in themselves. In the following description of the examples disclosed in the present specification, a detailed description of known functions and configurations incorporated herein will be omitted if the same may make the subject matter of the examples disclosed in the present specification rather unclear. In addition, the accompanying drawings are provided only for a better understanding of the examples disclosed in the present specification and are not intended to limit the technical ideas disclosed in the present specification.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

It will be understood that if a component is referred to as being “connected to” or “coupled to” another component, it may be directly connected to or coupled to the other component, or intervening components may be present. As used herein, the singular forms “a”, “an”, and “the” are intended to include the plural forms as well, unless the context clearly indicates otherwise.

It will be further understood that the terms “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip”, “second chip”, respectively.

The expression “based on” as used herein is intended to describe one or more factors that influence an act or operation of determining or deciding described in a phrase or sentence including that expression, and this expression does not exclude any additional factors that influence the act or operation of determining or deciding.

The first direction X, the second direction Y, and the third direction Z described herein are used to describe a three-dimensional shape, and refer to respective dimensions and directions thereof in a three-dimensional coordinate system.

Thus, the first direction X, the second direction Y, and the third direction Z may be indicated by arrows intersecting each other perpendicularly at one point in space.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The present disclosure relates to a device 200 for cooling a battery system 100 of a vehicle 1.

The device 200 for cooling the battery system 100 of the vehicle 1 according to the present disclosure may maintain the temperature of the battery system 100 at an appropriate level, thereby increasing the performance and lifespan of the battery system 100.

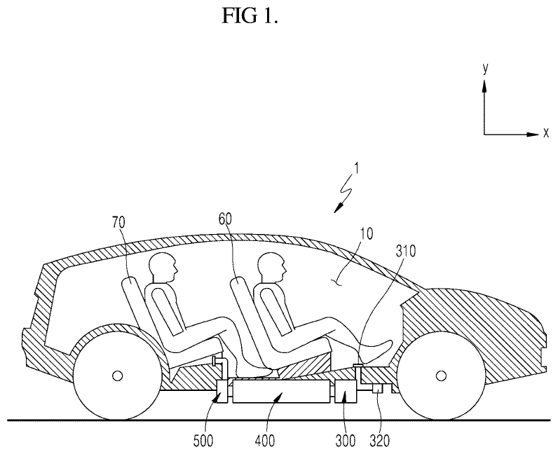

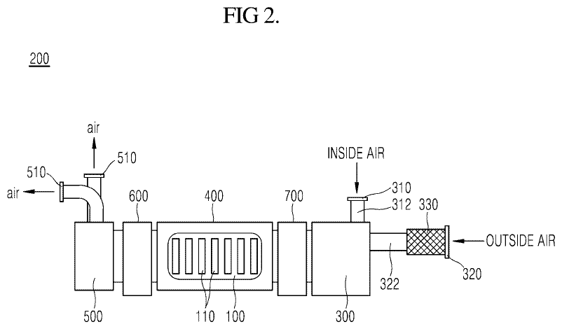

FIG. 1 is a schematic view for explaining the device 200 for cooling the battery system 100 of the vehicle 1 according to an example of the present disclosure, and FIG. 2 is a view schematically showing the device 200 for cooling the battery system 100 of the vehicle 1 according to the example of the present disclosure.

As shown in FIGS. 1 and 2, a vehicle 1 (e.g., a hybrid electric vehicle (HEV) or an electric vehicle) may be equipped with the battery system 100 to store electric energy.

The battery system 100 may comprise a plurality of battery cells 110. The plurality of battery cells 100 may be densely disposed (e.g., packed physically adjacent and/or near each other) and protected by a battery housing 120. The battery system 100 may generate heat during operation thereof. Due to the structure in which the battery cells are densely disposed, the entirety or part of the battery system 100 may overheat.

If the temperature of the battery system 100 increases, efficiency with which the battery system 100 stores and supplies electric energy may be reduced (e.g., sharply), and the lifespan of the battery cells 110 may be shortened.

The cooling device 200 according to the example of the present disclosure may be an air-cooling type cooling device for preventing sudden increase in temperature of the battery system 100 and/or maintaining the temperature of the battery system 100 within a predetermined temperature range.

The cooling device 200 according to the example of the present disclosure may include an inlet duct 300, a cooling duct 400, an outlet duct 500, a blower fan 600, a controller 800, and/or a filter unit 330.

The inlet duct 300 may comprise/form an entrance into which air may be introduced. The inlet duct 300 may include an inside air introduction port 310 and/or an outside air introduction port 320. The inside air introduction port 310 may comprise/form an entrance connected to an interior space 10 of the vehicle 1, and the outside air introduction port 320 may comprise/form an entrance extending to the outside of the vehicle 1 to receive outside air.

The inlet duct 300 may suction inside air from the interior space 10 of the vehicle 1 and/or suction outside air from the outside of the vehicle 1, and supply the suctioned air to the cooling duct 400.

The inlet duct 300 may have/form an inlet space 302 as a space defined therein so as to have a predetermined size. The inside air introduction port 310 may be connected to the inlet space 302 via an inside air introduction passage 312, and the outside air introduction port 320 may be connected to the inlet space 302 via an outside air introduction passage 322.

In the example of the present disclosure, the battery system 100 is accommodated in the cooling duct 400.

The cooling duct 400 may include one or more (e.g., a series) of cooling passages formed to allow air to flow into and out of the battery housing 120 of the battery system 100 accommodated in the cooling duct 400 or to flow between the battery cells 110.

That is, the inside air in the interior space 10 of the vehicle 1 and/or the outside air of the vehicle 1 may be introduced into the inlet duct 300, and then moves to the cooling duct 400. The air reaching the cooling duct 400 may flow along a predetermined cooling passage formed in the cooling duct 400.

The air flowing along the cooling passage formed in the cooling duct 400 may absorb and/or remove heat from the battery system 100, thereby lowering the temperature of the battery system 100.

The air having passed through the cooling duct 400 may flow to the outlet duct 500, and then be discharged via the outlet duct 500.

The outlet duct 500 may include an outlet space (e.g., as a predetermined space defined therein). The air having absorbed heat from the battery system 100 via the cooling duct 400 may be introduced into the outlet space of the outlet duct 500. The air introduced into the outlet duct 500 may be discharged to the interior space 10 of the vehicle 1 via at least one discharge port 510.

A blower fan 600 may be provided in the inlet duct 300. The blower fan 600 may be mounted in the inlet space 302 of the inlet duct 300. The blower fan 600 may cause air to flow in a first direction (e.g., from the inside air introduction passage 312 and/or the outside air introduction passage 322) toward a connection passage 304 connected to the cooling duct 400.

The blower fan 600 may suction air from the inside air introduction port 310 and/or the outside air introduction port 320 to the inlet space 302, and cause the introduced air to flow to the cooling duct 400 via the connection passage 304.

As described herein, the blower fan 600 may be mounted in the inlet duct 300 and/or provided between the inlet duct 300 and the cooling duct 400. Accordingly, the blower fan 600 may form an airflow in the first direction for cooling of the battery system 100 and/or may form a strong airflow in a direction opposite the first direction (e.g., toward the filter unit 330 mounted to the outside air introduction port 320), thereby achieving effective cleaning of the outside air introduction port 320 and/or the filter unit 330.

However, this is merely given by way of example. The blower fan 600 may be mounted between the cooling duct 400 and the outlet duct 500, for example, in order to more strongly induce the flow of air passing through the battery system 100. The blower fan 600 may be placed at an appropriate position depending on design objectives of examples of the present disclosure. Multiple blower fans 600 may be placed at multiple locations as disclosed herein.

The controller 800 may collect (e.g., via one or more temperature sensors) information about the temperature of the battery system 100, the temperature of each of the battery cells 110, the temperature of the interior space 10 of the vehicle 1, and/or the temperature outside the vehicle 1, and may control, based on the collected information, operation of the blower fan 600 and/or an air-conditioning device of the vehicle 1 (e.g., according to predetermined and/or input settings).

Also, or alternatively, the device 200 for cooling the battery system 100 of the vehicle 1 may further include a heat exchange unit 700. The heat exchange unit 700 may be mounted in the air flow passage spanning the inlet duct 300, the cooling duct 400, and/or the outlet duct 500. The heat exchange unit 700 may be provided in the inlet duct 300 or the cooling duct 400, for example. The heat exchange unit 700 may cool air flowing therethrough to a predetermined temperature.

However, this is merely given by way of example. The temperature of air to be supplied to the cooling duct 400 may be lowered by the air-conditioning device in the interior space 10 of the vehicle 1, and/or low-temperature outside air may be utilized without a separate cooling process depending on the driving situation of the vehicle 1 or the temperature of the outside air. Therefore, the heat exchange unit 700 does not necessarily need to be mounted/included in order to implement the present disclosure.

The device 200 for cooling the battery system 100 of the vehicle 1 according to the example of the present disclosure may be provided under a vehicle body floor 20 forming the bottom surface of the vehicle body.

A shape of the vehicle body floor 20 may depend on design of the vehicle 1. The vehicle body floor 20 may include a vehicle body transverse member, which is a structure formed in the transverse direction of the vehicle body, a vehicle body longitudinal member, which is a structure formed in the longitudinal direction of the vehicle body, a raised portion, which is a portion protruding upward from at least a portion of the surface thereof, and/or a depressed portion, which is a portion depressed downward from at least a portion of the surface thereof.

Front seats 60 (e.g., which correspond to a driver seat and a front passenger seat) may be mounted on a portion of the upper surface of the vehicle body floor 20. Rear seat(s) 70, which correspond to rear passenger seat(s), may be mounted behind the front seats 60.

The inlet duct 300, the cooling duct 400, and/or the outlet duct 500 may be provided under the vehicle body floor 20. The inside air introduction port 310 provided at the inlet duct 300 and the discharge port 510 provided at the outlet duct 500 may extend to the interior space 10 of the vehicle 1 through the vehicle body floor 20.

The filter unit 330 may be mounted to the outside air introduction port 320 provided at the inlet duct 300. The filter unit 330 may prevent water or foreign substances from entering the inlet duct 300 via the outside air introduction port 320.

The filter unit 330 may be formed to be separably coupled to the outside air introduction port 320.

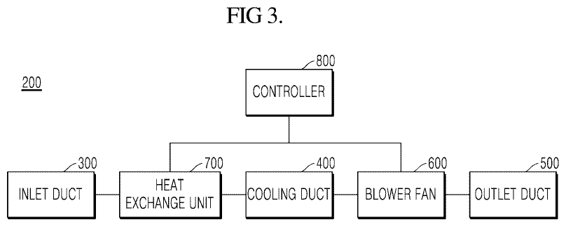

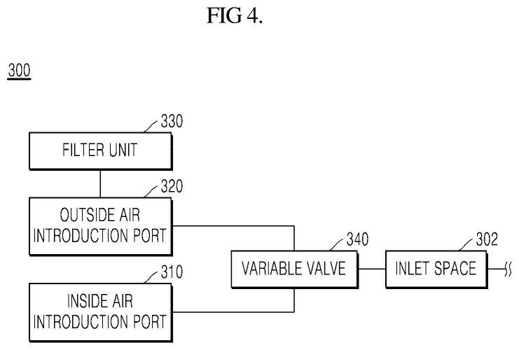

FIG. 3 is a block diagram for explaining the device 200 for cooling the battery system 100 of the vehicle 1 according to the example of the present disclosure, and FIG. 4 is a block diagram for explaining the inlet duct 300 in the device 200 for cooling the battery system 100 of the vehicle 1 according to the example of the present disclosure.

As shown in FIGS. 3 and 4, in the device 200 for cooling the battery system 100 of the vehicle 1 according to the example of the present disclosure, an inlet duct 300, a cooling duct 400, a blower fan 600, and an outlet duct 500 may be sequentially disposed in the air flow direction. Alternatively, in the cooling device 200 according to another example of the present disclosure, the inlet duct 300, the blower fan 600, the cooling duct 400, and the outlet duct 500 may be sequentially disposed in an order different from the order shown in the drawings.

The inlet duct 300 may include/form an inlet space 302 as a predetermined space defined therein, and/or may include/form an inside air introduction port 310 and an outside air introduction port 320 as entrances connected to the inlet space 302 to guide air to the inlet space 302.

The inside air introduction port 310 may be connected to the interior space 10 of the vehicle 1, and may be connected to the inlet space 302 through an inside air introduction passage 312. The outside air introduction port 320 may include/form an outside air entrance formed so as to face forward in the travel direction of the vehicle 1, and may be connected to the inlet space 302 via an outside air introduction passage 322.

As described herein, the filter unit 330 is mounted to the outside air introduction port 320.

The inlet duct 300 may also, or alternatively, include a variable valve 340 (e.g., a valve configured to control air input from variable sources). The variable valve 340 may be mounted in the inlet space 302, and may be configured to open or close the inside air introduction passage 312 and/or the outside air introduction passage 322 connected to the inlet space 302.

The variable valve 340 may be controlled by the controller 800 (e.g., the controller 800 may be configured to cause the variable valve 340) to close or open the inside air introduction passage 312 and/or the outside air introduction passage 322 connected to the inlet space 302.

Also, or alternatively, the variable valve 340 may be controlled by the controller 800 to close the inside air introduction passage 312 connected to the inlet space 302 and/or open the outside air introduction passage 322 connected to the inlet space 302.

Also, or alternatively, the variable valve 340 may be controlled by the controller 800 to open the inside air introduction passage 312 connected to the inlet space 302 and/or close the outside air introduction passage 322 connected to the inlet space 302.

The controller 800 may control operation of the blower fan 600, the air-conditioning device of the vehicle 1, the heat exchange unit 700, and/or the variable valve 340. In the example of the present disclosure, the controller 800 may perform control such that the blower fan 600 causes air to flow in the first direction in a state in which at least one of the inside air introduction passage 312 or the outside air introduction passage 322 is open.

Also, or alternatively, the blower fan 600 may cause air to flow in a second direction, which is opposite the first direction, under the control of the controller 800.

The second direction may be a direction from the inlet space 302 toward the filter unit 330 mounted to the outside air introduction port 320. The controller 800 may perform control such that the blower fan 600 forms a strong airflow in the second direction in a state in which the inside air introduction passage 312 is closed and the outside air introduction passage 322 is open.

To this end, the outside air introduction passage 322 connected to the inlet space 302 may be formed in a straight shape so as to face forward, and the blower fan 600 may be disposed on a straight line with the outside air introduction passage 322, the outside air introduction port 320, and the filter unit 330.

The blower fan 600 forming an airflow (e.g., of a sufficient strength) in the second direction may remove foreign substances attached to the filter unit 330 may be removed.

The device 200 for cooling the battery system 100 of the vehicle 1 according to the example of the present disclosure may further include a sensing module configured to measure predetermined data values, e.g., the temperature of the battery system 100, the temperature of the inside air, and the temperature of the outside air, and transmit the measured data values to the controller 800.

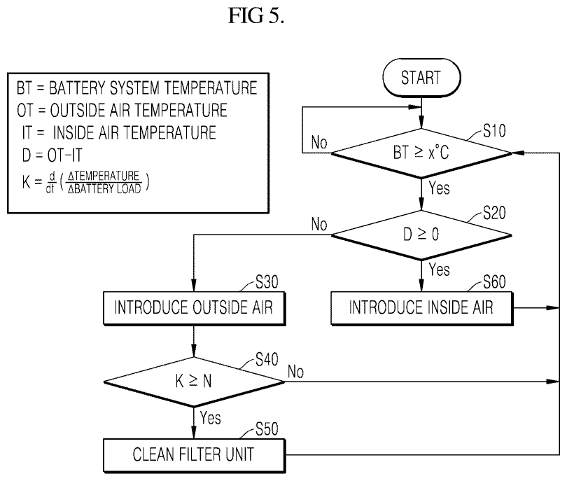

FIG. 5 is a flowchart for explaining a method of operating the device 200 for cooling the battery system 100 of the vehicle 1 according to an example of the present disclosure. For convenience, FIG. 5 is described by way of an example in which the steps are performed by a processor circuit. One, some, or all steps of the example method of FIG. 5, or portions thereof, may be performed by one or more other circuits. One or some, steps of the example method of FIG. 5 may be omitted, performed in other orders, and/or otherwise modified, and/or one or more additional steps may be added.

As shown in FIG. 5, the method of operating the device 200 for cooling the battery system 100 of the vehicle 1 according to the example of the present disclosure includes battery system monitoring S10 of monitoring whether the temperature of the battery system 100 is equal to or higher than a predetermined temperature X.

If it is determined in the battery system monitoring S10 that the temperature of the battery system 100 or at least one of the battery cells 110 is equal to or higher than the predetermined temperature X, a cooling condition determination S20 may be performed. The cooling condition determination may comprise obtaining a value D by subtracting the temperature IT of the inside air from the temperature OT of the outside air and determining whether the value D satisfies a threshold (e.g., is equal to or greater than zero). Also, or alternatively, the cooling condition determination may comprise obtaining the value D by subtracting the temperature IT and to an acceptable inside air temperature threshold (e.g., a default internal temperature and/or input temperature, such as from a user of the vehicle) (e.g., D may be determined based on an acceptable temperature). If IT is greater than or equal to the acceptable inside air temperature, the value D may be recalculated based on the OT as above.

If the value D calculated in the cooling condition determination S20 does not satisfy a threshold (e.g., is a negative value), the temperature IT of the inside air is higher than the temperature OT of the outside air. In this case, the outside air is selected as the air to be used for cooling the battery system 100.

Based on outside air being chosen for cooling the battery system 100, the variable valve 340 may close the inside air introduction passage 312 and open the outside air introduction passage 322, performing outside air introduction (S30) to allow the outside air to flow in.

In the outside air introduction S30, and/or after/based on the outside air interaction S30, filter monitoring S40 may be performed.

The filter monitoring S40 may comprise obtaining a constant K based on a ratio of increase in temperature of the battery system 100 per unit time to battery load consumed per unit time (e.g., a change in charge of the battery, e.g., based on charge information from a voltage or charge sensor associated with the battery). It may be determined whether the obtained constant K satisfies a threshold, such as being equal to or greater than a predetermined value N. If the constant K is satisfies the threshold (e.g., is equal to or greater than the predetermined value N), the outside air introduction S30 may be terminated, and filter unit cleaning S50 may be performed.

In the filter unit cleaning S50, the controller 800 may control the variable valve 340 to close the inside air introduction passage 312 and/or open the outside air introduction passage 322, and/or may control the blower fan 600 to form an airflow in the second direction. Thus, if the outside air is not smoothly introduced (e.g., due to foreign substances attached to the filter unit 330), the controller 800 may automatically perform the filter unit cleaning S50 to remove obstacles from the filter unit 330 and the outside air introduction port 320.

If the constant K obtained based on a ratio of increase in temperature of the battery system 100 per unit time to battery load consumed per unit time exceeds a predetermined value, it may be determined that the outside air is not smoothly introduced, and the filter unit cleaning S50 may be performed in order to secure smooth introduction of the outside air.

If the value D calculated in the cooling condition determination S20 is equal to or greater than 0, it can be determined that the temperature IT of the inside air is lower than the temperature OT of the outside air. Therefore, if the value D is equal to or greater than 0, inside air introduction S60 may be performed.

In the inside air introduction S60, the controller 800 may control the variable valve 340 to close the outside air introduction passage 322 and open the inside air introduction passage 312. The controller 800 may control the blower fan 600 to form an airflow in the first direction, so the inside air of the vehicle 1 circulates for cooling of the battery system 100.

The present disclosure solves a problem with the related art that it is difficult to maintain a comfortable interior temperature because an air-cooling type battery system cooling device for a vehicle performs cooling through circulation of inside air. The present disclosure also solves a problem with the related art that energy efficiency is low because a battery system cooling device has a structure of circulating air inside a vehicle and thus the inside air needs to be continuously cooled. The aspects of the present disclosure are not limited to those mentioned herein, and other aspects or objects not mentioned herein will be clearly understood by those skilled in the art from the present description.

A device for cooling a battery system of a vehicle provided with a multi-inlet duct according to an example of the present disclosure includes an inlet duct, a filter unit, a blower fan, a cooling duct, and an outlet duct. The inlet duct includes an inside air introduction port as an entrance to receive air from an interior space of a vehicle body and an outside air introduction port as an entrance to receive air from the outside of the vehicle body. The filter unit is mounted to the outside air introduction port to filter out moisture and particles having a predetermined size or greater. The blower fan is provided in the inlet duct to cause air to flow in a predetermined direction. The cooling duct allows air introduced into the inlet duct to exchange heat with the battery system while flowing along a predetermined path. The outlet duct is a passage for discharging air having passed through the cooling duct.

In the device for cooling a battery system of a vehicle provided with a multi-inlet duct according to the example of the present disclosure, the inlet duct may include an inside air introduction passage as an air flow passage connected to the inside air introduction port, an outside air introduction passage as an air flow passage connected to the outside air introduction port, an inlet space in which the inside air introduction passage and the outside air introduction passage join each other, and a connection passage as a passage connecting the inlet space to the cooling duct.

In the device for cooling a battery system of a vehicle provided with a multi-inlet duct according to the example of the present disclosure, the inlet duct may include a variable valve configured to open or close at least one of the inside air introduction passage or the outside air introduction passage.

The device for cooling a battery system of a vehicle provided with a multi-inlet duct according to the example of the present disclosure may include a controller configured to control operation of the variable valve and the blower fan under predetermined conditions.

In the device for cooling a battery system of a vehicle provided with a multi-inlet duct according to the example of the present disclosure, the controller may control the blower fan to cause air to flow in a first direction toward the cooling duct through the connection passage in a state in which at least one of the inside air introduction passage or the outside air introduction passage is open.

In the device for cooling a battery system of a vehicle provided with a multi-inlet duct according to the example of the present disclosure, the controller may control the blower fan to cause air to flow in a second direction from the inlet space toward the outside air introduction port under predetermined conditions.

The device for cooling a battery system of a vehicle provided with a multi-inlet duct according to the example of the present disclosure may include a sensing module configured to measure data on the temperature of the battery system, the temperature of inside air, and the temperature of outside air and transmit the measured data to the controller.

In the device for cooling a battery system of a vehicle provided with a multi-inlet duct according to the example of the present disclosure, the outside air introduction port may be provided under the vehicle body and may have an entrance facing forward.

In the device for cooling a battery system of a vehicle provided with a multi-inlet duct according to the example of the present disclosure, the filter unit may be mounted in the entrance of the outside air introduction port.

As is apparent from the present description, inside air or outside air may be selectively used for cooling of a battery system depending on the driving situation of a vehicle, whereby energy consumed for cooling of air may be saved.

According to the present disclosure, slipstream occurring during travel of a vehicle or low-temperature outside air may be utilized for cooling of a battery system, and accordingly, energy efficiency may be improved.

According to the present disclosure, it is possible to prevent introduction of water or foreign substances during introduction of outside air and to automatically remove foreign substances from an outside air introduction port or a filter, thereby preventing an air flow passage from narrowing.

The effects achievable via the disclosure are not limited to the herein-mentioned effects, and other effects not mentioned herein will be clearly understood by those skilled in the art from the present description.

The examples of the present disclosure have been described herein with reference to the accompanying drawings. However, the examples are only proposed for illustrative purposes, and the present disclosure is not limited to the herein-described examples and the accompanying drawings. The scope of the present disclosure should be defined by the technical spirit set forth in the appended claims.

In addition, although not all actions or effects according to the configuration of the examples have been explicitly described, it is apparent that actions or effects predictable from the configuration should also be recognized as falling within the spirit and scope of the present disclosure.

What is claimed is:

1. A device for air-cooling a battery system, the device comprising:
an inlet duct comprising:
an inside air introduction port configured to receive air from an interior space of a vehicle body, and
an outside air introduction port configured to receive air from outside of the vehicle body;
a filter configured to filter, from air received from the outside air introduction port, moisture or particles having at least a predetermined size;
a blower fan configured to cause air, from the inlet duct, to flow in a first direction;
a cooling duct configured to allow air, introduced via the inlet duct, to exchange heat with the battery system while flowing along a predetermined path; and
an outlet duct configured to discharge air from the cooling duct.

2. The device according to claim 1, wherein the inlet duct further comprises:
an inside air introduction passage configured to allow air flow from the inside air introduction port to an inlet space;
an outside air introduction passage configured to allow air flow from the outside air introduction port to the inlet space; and
a connection passage connecting the inlet space to the cooling duct.

3. The device according to claim 2, wherein the inlet duct further comprises a valve configured to open or close at least one of the inside air introduction passage or the outside air introduction passage.

4. The device according to claim 3, further comprising a controller configured to control:
the valve and the blower fan.

5. The device according to claim 4, wherein the controller is configured to, based on at least one of the inside air introduction passage of the outside air introduction passage being open, control the blower fan to cause air to flow, via the connection passage, in the first direction toward the cooling duct.

6. The device according to claim 4, wherein the controller is configured to control the blower fan to cause air to flow in a second direction from the inlet space toward the outside air introduction port.

7. The device according to claim 4, further comprising one or more temperature sensors configured to:
measure data indicating one or more of:
a temperature of the battery system,
a temperature of inside air, or
a temperature of outside air; and
transmit the measured data to the controller.

8. The device according to claim 1, wherein the outside air introduction port is provided under the vehicle body and forms an entrance facing a forward direction of the vehicle body.

9. The device according to claim 8, wherein the filter is mounted in an entrance of the outside air introduction port.

10. The device according to claim 4, wherein the controller comprises one or more processors and a memory storing instructions that, when executed by the one or more processors, configure the controller to:
receive, from one or more temperature sensors, an outside air temperature of air outside of the vehicle body and an inside air temperature of air inside the vehicle body; and
control, based on a comparison of the received outside air temperature and the received inside air temperature, the valve of the inlet duct.

11. The device according to claim 10, wherein the instructions, when executed by the one or more processors, further configure the controller to:
control, based on the comparison indicating the outside air temperature is greater or equal to than the inside air temperature, the valve of the inlet duct to open the inside air introduction port and close the outside air introduction port.

12. The device according to claim 10, wherein the instructions, when executed by the one or more processors, further configure the controller to:
control, based on the comparison indicating the outside air temperature is less than the inside air temperature, the valve of the inlet duct to close the inside air introduction port and open the outside air introduction port.

13. The device according to claim 12, wherein the instructions, when executed by the one or more processors, further configure the controller to:
determine a ratio of temperature change of the battery system to load change of the battery system; and
controlling, based on the ratio, the blower fan.

14. The device according to claim 13, wherein the instructions, when executed by the one or more processors, further configure the controller to:
base on the ratio satisfying a threshold:
control the valve to close the outside air introduction port; and
control the blower fan to blow in a second direction towards the filter.

15. A method for air cooling a battery system of a vehicle, the method comprising:
receiving, by a computing device and from one or more temperature sensors, an outside air temperature of air outside of the vehicle and an inside air temperature of air inside the vehicle; and
controlling, by the computing device and based on a comparison of the received outside air temperature and the received inside air temperature, a valve of an inlet duct to a cooling duct configured to exchange heat with the battery system.

16. The method of claim 15, further comprising
controlling, by the computing device and based on the comparison indicating the outside air temperature is greater or equal to than the inside air temperature, the valve to open an inside air introduction port and close an outside air introduction port so that air moves from inside the vehicle into the cooling duct.

17. The method of claim 15, further comprising:
controlling, by the computing device and based on the comparison indicating the outside air temperature is less than the inside air temperature, the valve to close an inside air introduction port and open an outside air introduction port so that air moves from outside the vehicle into the cooling duct.

18. The method of claim 17, further comprising:
determining a ratio of temperature change of the battery system to load change of the battery system; and
controlling, based on the ratio, a blower fan to blow either in a first direction from the inlet duct to the cooling duct, or in a second direction opposite the first direction.

19. The method of claim 18, further comprising, based on the ratio satisfying a threshold:
controlling the valve to close the outside air introduction port; and
controlling the blower fan to blow in the second direction.

20. A vehicle comprising:
a battery system; and
a device for air-cooling the battery system, the device comprising:
an inlet duct comprising:
an inside air introduction port configured to receive air from an interior space of a vehicle body, and
an outside air introduction port configured to receive air from outside of the vehicle body;
a filter configured to filter, from air received from the outside air introduction port, moisture or particles having at least a predetermined size;
a blower fan configured to cause air, from the inlet duct, to flow in a first direction;
a cooling duct configured to allow air, introduced via the inlet duct, to exchange heat with the battery system while flowing along a predetermined path; and
an outlet duct configured to discharge air from the cooling duct.
